(19) United States
(12) Patent Application Publication
(10) Pub. No.: US 2015/0331980 A1
(43) Pub. Date: Nov. 19, 2015

(54) APPARATUS AND METHOD FOR CLASSIFYING CONTEXT TYPES FOR MULTIVARIATE MODELING

(71) Applicant: Applied Materials, Inc., Santa Clara, CA (US)

(72) Inventors: Jimmy ISKANDAR, Fremont, CA (US); Bradley D. SCHULZE, Phoenix, AZ (US); Parris HAWKINS, Los Altos, CA (US)

(21) Appl. No.: 14/713,943

(22) Filed: May 15, 2015

Related U.S. Application Data
(60) Provisional application No. 61/994,011, filed on May 15, 2014.

(51) Int. Cl. G06F 17/50; G06F 17/30

(52) U.S. Cl. CPC G06F 17/5009; G06F 17/30598; G06F 17/3053

(57) ABSTRACT

A method is provided for determining two or more context types having an associated fault to be modeled by the same multivariate model. The method includes selecting a fault and selecting two or more context types associated with the fault. The method further includes accessing data stored for the selected context types. The method further includes generating rankings of process data tags for each selected context type. Each ranking includes process data tags ranked according to relative contributions of each process data tag in the ranking to the fault. The method further includes classifying the context types into one or more classes based on the process data tags included in each ranking. The one or more classes include a first class of the context types. The method further includes deploying a multivariate model operable to monitor processing equipment for the selected fault for the first class of context types.

### CROSS REFERENCE TO RELATED APPLICATIONS

This application claims benefit of U.S. provisional patent application Ser. No. 61/994,011, filed May 15, 2014, which is herein incorporated by reference.

### FIELD

Embodiments disclosed relate generally to multivariate modeling of processes. More particularly, embodiments disclosed relate to a method and apparatus for determining whether a fault associated with two or more particular context types can be successfully modeled with the same multivariate model.

### BACKGROUND

Multivariate models can be used to detect when industrial processes are operating in an acceptable condition or a fault condition. Multivariate models enable operators of process-controlled equipment to monitor a relatively small number of metrics when compared to what can sometimes be an overwhelming number of data points monitored by a control system.

Multivariate models for a specific tool are often developed after a training period during which processes for the tool are repeated under controlled conditions and vast amounts of data, including faults and other events, are logged. The most relevant data is used to develop models for different portions of the processes. Then the models are tested to determine if the models accurately predict when the tool is operating in an acceptable condition or a fault condition. Once the models prove satisfactory, fault thresholds can be set, and the models can be deployed for use in production.

A properly developed multivariate model can provide numerous benefits to the owner of the modeled equipment. Product quality can be improved because the multivariate models can identify irregular process conditions that could not be identified by only monitoring individual data points. Additionally, downtime can be reduced because multivariate models can identify when a component is likely to fail, allowing for replacement during the next scheduled maintenance instead of during an unexpected shutdown caused by the failed part. Furthermore, maintenance costs can be reduced because the multivariate models can be used for Predictive Maintenance replacing parts only when maintenance is actually needed as opposed to traditional preventive maintenance, which replaced parts according to maintenance schedules regardless of whether the particular part actually needed maintenance or replacement.

Despite the benefits of using multivariate models, development of the models can be very time consuming and thus expensive. Sometimes a multivariate model can successfully predict common faults across similar machines or recipes. However, determining whether or not a multivariate model to be developed to predict a fault on one machine or recipe will eventually prove useful to accurately predict a similar fault on a similar machine or recipe can often be unclear.

Therefore, a need exists for an improved method and system for determining whether a multivariate model to be developed to predict a fault for one machine or recipe, will be useful for predicting faults on similar machines or recipes.

### SUMMARY

In one embodiment, a method is provided for determining two or more context types having an associated fault to be modeled by the same multivariate model. The method includes selecting a fault and selecting two or more context types associated with the fault. The method further includes accessing data stored for the selected context types. The method further includes generating rankings of process data tags for each selected context type. Each ranking includes process data tags ranked according to relative contributions of each process data tag in the ranking to the fault. The method further includes classifying the context types into one or more classes based on the process data tags included in each ranking. The one or more classes include a first class that includes two or more of the selected context types. The method further includes deploying a multivariate model operable to monitor processing equipment for the selected fault for the first class of context types.

In another embodiment, a system is provided for classifying context types for multivariate modeling of faults associated with the context types. The system includes a processor and a memory for storing data associated with the two or more context types and a code. The code is executed by the processor to perform operations. The operations include accepting a selection of a fault and a selection of two or more context types associated with the fault. The operations further include accessing historical values stored in the memory for process data tags related to the selected context types. The operations further include generating rankings of process data tags for each selected context type. Each ranking includes process data tags ranked according to relative contributions of each process data tag in the ranking to the fault. The operations further include classifying the context types into one or more classes based on the process data tags included in each ranking. The one or more classes include a first class that includes two or more of the selected context types. The second code when executed by the processor performs operations using a multivariate model to monitor processing equipment for the selected fault for the first class of context types.

In another embodiment, a non-transitory computer-readable storage medium storing code for execution by a processor is provided. When the code is executed by the processor, the processor performs operations for determining two or more context types associated with a fault to be modeled by the same multivariate model. The operations include accepting a selection of a fault and a selection of two or more context types associated with the fault. The operations further include accessing historical values stored in the memory for process data tags related to the selected context types. The operations further include generating rankings of process data tags for each selected context type. Each ranking includes process data tags ranked according to relative contributions of each process data tag in the ranking to the fault. The operations further include classifying the context types into one or more classes based on the process data tags included in each ranking. The one or more classes include a first class that includes two or more of the selected context types. The second code when executed by the processor, performs operations including using a multivariate model to monitor processing equipment for the selected fault for the first class of context types.

### BRIEF DESCRIPTION OF THE DRAWINGS

So that the manner in which the above recited features of the embodiments disclosed above can be understood in detail, a more particular description, briefly summarized above, may be had by reference to the following embodiments, some of which are illustrated in the appended drawings. It is to be noted, however, that the appended drawings illustrate only typical embodiments and are therefore not to be considered limiting of its scope to exclude other equally effective embodiments.

FIG. 1A is a block diagram of a context type classifying system according to one embodiment.

FIG. 1B is a block diagram of a memory to be incorporated in one embodiment.

FIGS. 2A-2E are block diagrams illustrating exemplary modes of classifying context types, according to one embodiment.

FIG. 3 is a process flow diagram of a process for determining context types associated with a fault to be modeled by the same multivariate model according to one embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Embodiments disclosed relate generally to multivariate modeling of processes. More particularly, embodiments disclosed relate to a method and apparatus for determining whether a fault associated with two or more particular context types can be successfully modeled with the same multivariate model. The embodiments disclosed further relate to developing multivariate models and a fault code to detect multivariate faults associated with two or more of the selected context types.

Context types refer to any equipment, machines, processes, portions of processes, or events that can be monitored by a control system. Examples of context types include, but are not limited to the following: a tool, a piece of equipment, a system of multiple tools or equipment, a recipe, a sequence, an event (e.g., a maintenance event, an occurrence of a condition, a specific point in a recipe, etc.), or any combination thereof. The amount of detail associated with a context type can vary substantially. An example of a broad context type could be Recipe A (not associated with any specific tool or piece of equipment). An example of a much narrower context type could be Step 17 of Recipe A on Tool 10.

A fault occurring in process-controlled equipment can be associated with multiple context types. A fault could be associated with multiple context types within a single machine. For example, a fault caused by an arcing electrode in Machine 1 can occur during Recipe A and Recipe B executed on Machine 1. A fault could also be associated with multiple context types across different machines or pieces of equipment. For example, if Machines 1 and 2 both have a similar electrode that can arc, then a fault caused by an arcing electrode could occur during Recipes A and B on Machine 1, and a similar fault caused by a similar arcing electrode could occur during recipe A, C and D on Machine 2. Developing a separate multivariate model to detect an arcing electrode fault for each context type (e.g., each recipe and machine) is time consuming and not cost effective.

Embodiments described here disclose a system and method for identifying the similar context types, which can benefit from a multivariate model developed for a similar fault across the context types. The system and method disclosed can be used to classify the multiple context types into on or more classes. Potentially similar context types, which can benefit from the multivariate model developed, can be identified by analyzing historical data of the context types. The historical data for each context type can be used to generate a ranking of process data tags contributing most to the fault associated with the context type. Subsequently, a multivariate model can be developed for a particular class and then the multivariate model can be deployed along with a fault routine, so that the context types within that particular class can be monitored for occurrence of the similar fault. The multivariate model can be developed using machine-learning techniques, such as Neural Network and Random Forest.

A process data tag is any identifiable value, which is associated with a process or piece of equipment and which can be monitored. Examples of process data tags include process variables and process parameters. Process variables are physical values and conditions sampled over time that indicate the state of a process or equipment. Examples of process variables include temperatures, pressures, flow rates, voltages, amperages, and other physical characteristics that can be monitored in process. Process parameters include any other variable that can be monitored in a process or equipment. Examples of process parameters could include, but are not limited to operator settings, the value of any signal transmitted or received by a computing system controlling or monitoring a process or equipment, any computed value from a calculation involving one or more process variables (e.g., a mean, standard deviation, variance, minimum, maximum, or a range), or any other computed value associated with a process or equipment.

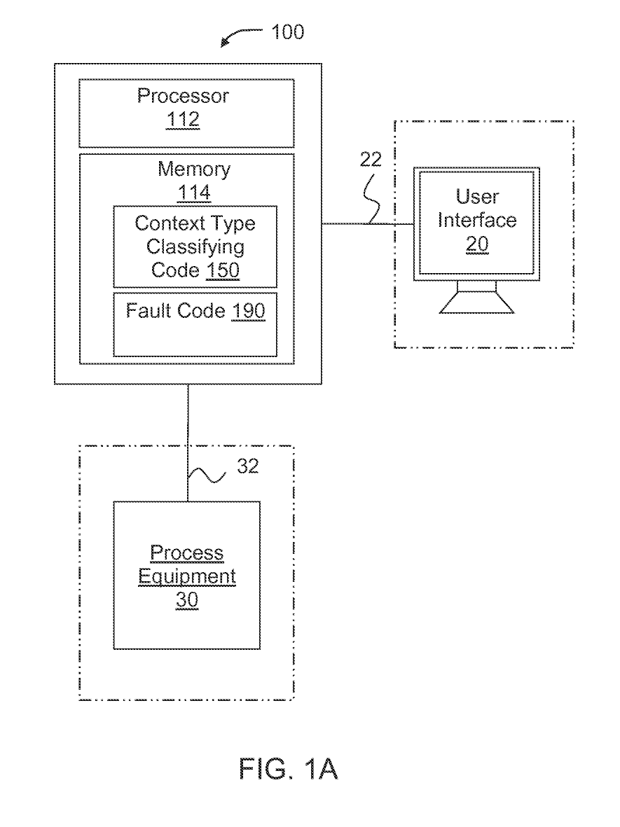

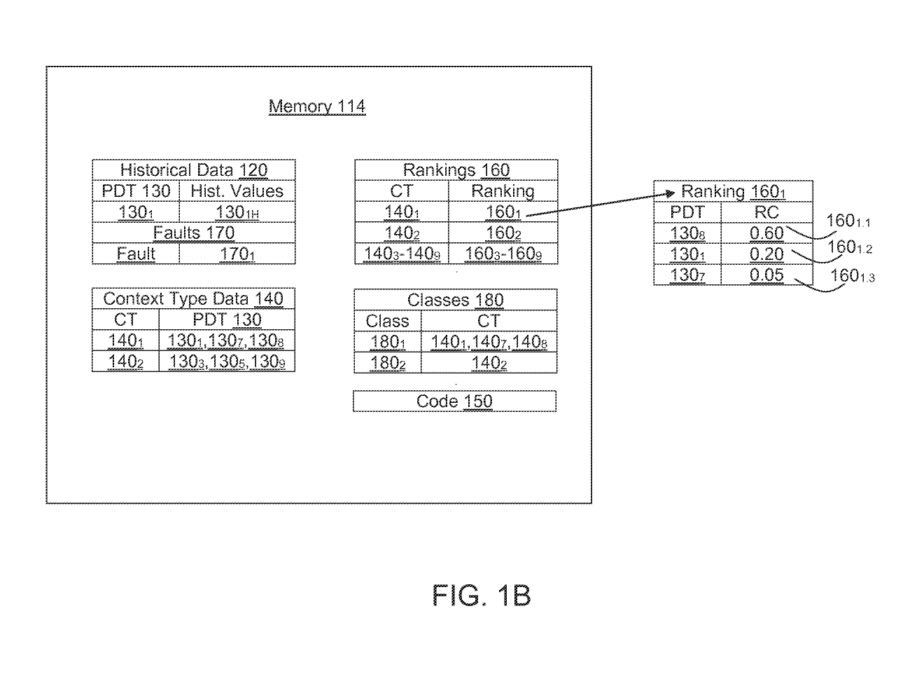

FIG. 1A is a block diagram of a context type classifying system 100 according to one embodiment. The context type classifying system 100 can be used for classifying context types, such as a context type 140₁ of FIG. 1B for multivariate modeling. The context type classifying system 100 includes at least a processor 112 and at least a memory 114. The memory 114 includes a context type classifying code 150 (a first code) to be executed by processor 112. As is described in more detail below, the context type classifying code 150 can be used to classify context types to facilitate identification of faults across context types that can be successfully modeled by the same multivariate model. The memory 114 may also include a fault code 190 (a second code). The fault code 190 can be used during processing to determine when a multivariate fault occurs. The fault code 190 can include a fault routine that includes conditions for determining when a process associated with the context types of a particular class (e.g., a first class) is in a fault condition with respect to a multivariate model developed for the selected fault. The multivariate model may be deployed to monitor processing equipment for the selected fault for the first class of context types. The multivariate model may also be stored in the fault code 190. The multivariate model can be developed for a particular class (e.g., a first class) of context types after the classification code 150 classifies the context types into the different classes.

The processor 112 can include one or more central process units (CPU's) distributed among one or more devices (e.g., server, personal computer, etc.). A CPU can include one or more processing components, such as a single-core processor, multi-core processor, microprocessor, integrated circuit (IC), application specific IC (ASIC), etc. Furthermore, the memory 114 can include memory distributed among one or more devices (e.g., server, personal computer, etc.) and include various types of memory components, such as random access memory (RAM), read only memory (ROM), cache, hard disk memory, solid-state memory, external storage media, etc. For example, the context classifying code 150 may be stored in a memory in one device and the fault code 190 may be stored in another device. The fault code 190 may also be distributed among multiple devices. For example, the context types classified into the same class could be machines installed at different locations and the fault code 190 including the fault routine and the multivariate model may be deployed on a device, such as a server, at each of those locations. Using a local copy of the fault code 190 for each context type, such as a machine, can help to ensure that the fault code 190 can be used to monitor the context type without interruptions, such as internet connectivity interruptions.

In some embodiments, the context type classifying system 100 can be operatively coupled to at least one user interface 20 through user interface communication link 22. The user interface 20 can be a graphical user interface (GUI) with a display (e.g., a monitor, screen, handheld device, television, etc.) with one or more input devices (e.g., a mouse, stylus, touch screen, touch pad, pointing stick, keyboard, or keypad).

In some embodiments, the context type classifying system 100 can be operatively coupled to process equipment 30 through a process equipment communication link 32. The process equipment 30 can include all of the field devices (e.g., actuators and sensors) and controllers and other equipment used to run one or more processes having associated context types to be analyzed by the context type classifying system 100. The process equipment 30 can also include all of the networking equipment (e.g., routers, switches, servers, gateways, firewalls, etc.) necessary for the context type classifying system 100 to communicate to process equipment 30. The context type classifying system 100 can communicate to the process equipment 30 over various types of networks, such as a local area network (LAN), wide area network (WAN), or virtual private network (VPN) allowing the context type classifying system 100 to be located remotely or locally with respect to the process equipment 30.

In other embodiments, the part of the context type classifying system 100 that executes the context classifying code 150 does not have any communication link to any process equipment. In such embodiments, data collected from one or more processes can be stored or loaded into the memory 114 to allow the processor 112 to execute the context type classifying code 150 on the collected data. As described above, the part of the context type classifying system 100 that includes the fault code 190 does have a communication link to the context types, such as processing equipment, that the fault code 190 is being used to monitor.

FIG. 1B is a block diagram of a portion of the memory 114 to be incorporated in one embodiment. Referring to FIGS. 1A and 1B, the memory 114 can store different types of data, variables, and code, some of which are described below to be used when the context classifying code 150 is executed. In the following description, a subscript “n” denotes an individual, but non-specific element of a group of elements. For example, an individual process data tag 130ₙ is included in a group of process data tags 130. Elements with the subscript “n” are not shown in the Figures.

The memory 114 can store historical data 120 for process data tags 130 (abbreviated as “PDT” in the Figures). For example, the historical data 120 can include historical values 130_{1H} for a process data tag 130₁, which can be the value of an amperage of a circuit. The historical data 120 can also include other historical values for numerous other process data tags 130. In some embodiments, there can be hundreds, thousands, or more process data tags 130 and corresponding historical values included in the historical data 120. The historical data 120 can also include occurrences of faults 170. The faults 170 are multivariate faults that cannot be detected by monitoring one process data tag 130. For example, a fault 170₁ can be an arcing electrode that is only detectable by monitoring multiple process data tags 130, such as tags related to an amperage, a temperature and a voltage. Occurrences of the multivariate faults 170 can be manually logged into the memory 114 by a user during a training period, during which large amounts of other historical data are automatically logged. Alternatively, if a control system is already capable of detecting a multivariate fault 170, for at least one of the context types 140ₙ, then at least some of the occurrences of the multivariate fault 170ₙ can be automatically logged into the memory 114.

The memory 114 can also store context types 140 (abbreviated as “CT” in the Figures). The context types 140 can include all of the relevant process data tags 130 for each individual context type 140ₙ. For example, a context type 140₁ could be a Recipe A on Tool 1 and the related process data tags 130₁, 130₇, and 130₈ could be a, a temperature, a voltage, and an amperage respectively. In some embodiments, the process data tags 130 could be process parameters, such as a mean, standard deviation, or a variance, of process variables. A context type 140₂ is shown with associated process data tags 130₃, 130₈, 130₉. There could be many more than three process data tags 130 for a given context type 140ₙ as this example is somewhat simpler for illustrative purposes.

The memory 114 can also store the context type classifying code 150. Thus, the memory 114 can be used to for storing data, such as the historical data 120 associated with two or more context types 140, the context type classifying code 150, and the fault code 190. The data, the context type classifying code 150 and the fault code 190 can be stored in a non-transitory computer-readable storage medium. Examples of non-transitory computer-readable storage mediums include but are not limited to a hard disk drive, a solid-state memory, a network attached storage (NAS), a read-only memory, a flash memory device, a CD-ROM (Compact Disc-ROM), a CD-R, or a CD-RW, a DVD (Digital Versatile Disc), a magnetic tape, and other optical and non-optical data storage devices. The non-transitory computer readable medium can also be distributed over a network coupled computer system, so that the computer readable code is stored and executed in a distributed fashion.

The context type classifying code 150 can be executed by the processor 112 to perform operations for classifying context types 140 for multivariate modeling of a fault 170ₙ associated with each context type 140ₙ. The operations of context type classifying code 150 can include accepting input for a selection a fault 170ₙ and two or more context types 140. The inputs for the selection of the fault 170ₙ and two or more context types 140 can also be stored in memory 114. The operations can further include accessing historical values stored in the memory 114 for process data tags 130 related to the selected context types 140. For example, if context type 140₁ is one of the selected context types 140, then the operations can include accessing historical values 130_{1H}, 130_{7H}(not shown), and 130_{8H}(not shown) stored in the memory 114 for the process data tags 130₁, 130₇, and 130₈.

The operations of context type classifying code 150 can further include generating rankings 160 of process data tags 130 for each selected context type 140ₙ. A ranking 160₁ is displayed as a table, but can be displayed as any common way to display a ranking, such as a histogram. In some embodiments, the rankings 160 can be displayed to a user, such as being displayed on the user interface 20. The rankings 160 can also be stored in the memory 114. Thus, there can be a ranking 160ₙ generated for each selected context type 140ₙ. For example, the ranking 160₁ can correspond to a ranking for context type 140₁, and a ranking 160₂ can correspond to a ranking for context type 140₂ and so on and so forth. Each ranking 160ₙ can include process data tags 130 ranked according to relative contributions (abbreviated as “RC” in the Figures) of each process data tag 130ₙ in the ranking 160ₙ to occurrence of a fault 170ₙ associated with the context type 140ₙ. For example, the ranking 160₁ shows process data tags 130₈, 130₁, and 130₇ according to respective relative contributions 160_{1.1}, 160_{1.2}, and 160_{1.3} to the occurrence of a fault 170, such as fault 170₁.

The context type classifying code 150 can be executed to generate the rankings 160 by using multivariate analysis techniques, such as Partial Least Squares, AdaBoost, and RankBoost. For example, the relative contributions, such as relative contributions 160_{1.1}-160_{1.3} in the ranking 160₁ can be determined by executing a Partial Least Squares on the historical data 120 to determine that the top three contributors to a fault 170₁ were process data tags 130₈, 130₁, and 130₇. Continuing the example, the Partial Least Squares analysis can compare the historical data 120 around each occurrence of the fault 170₁ for the context type 140₁ to the other historical data 120 related to the context type 140₁. If the fault 170₁ is a fault caused by an arcing electrode and context type 140₁ is a Recipe A on Tool 1, then the Partial Least Squares can compare the historical data 120 recorded during Recipe A on Tool 1 surrounding the occurrences of the fault caused by the arcing electrode to the historical data 120 recorded during Recipe A on Tool 1 in the absence of any faults or to the historical data 120 sometime before the occurrences of the fault 170₁, such as about one minute before the fault or about one hour before the fault. The time ranges of the historical data 120 compared during the multivariate analysis can depend on the process and the type of fault. The historical data 120 may reveal that some faults 170 occur suddenly while others slowly develop.

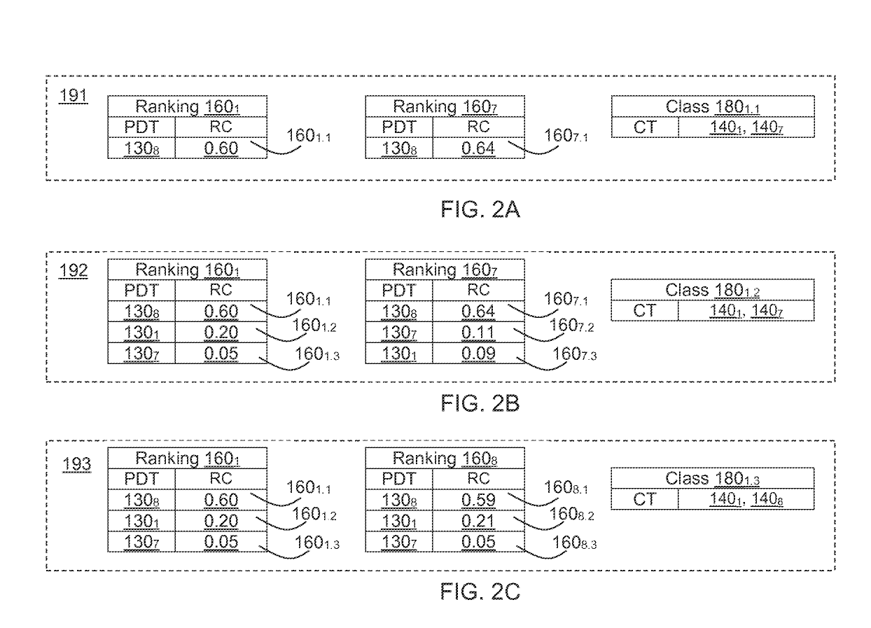

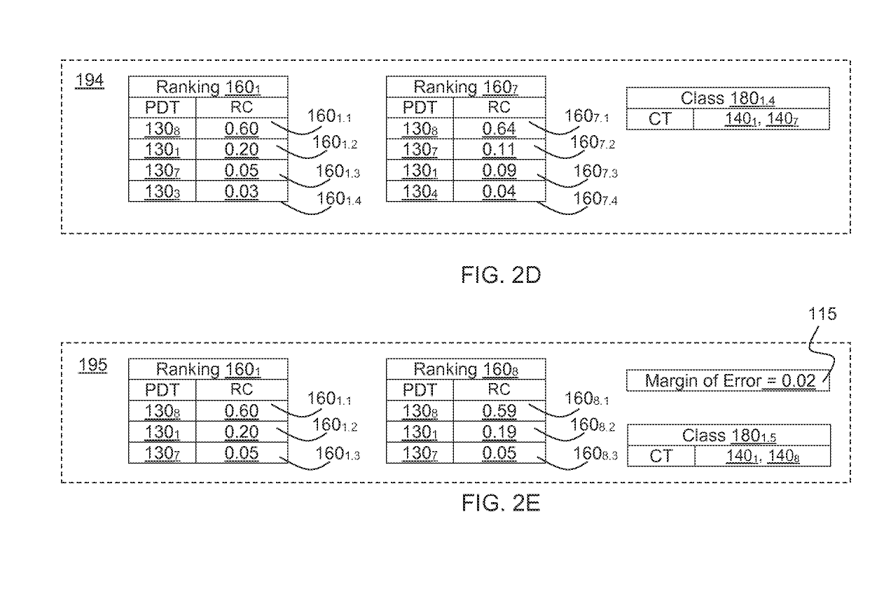

The operations of the context type classifying code 150 can further include classifying the context types 140 into one or more classes 180 based on the process data tags 130 included in each ranking 160ₙ. The classes 180 can also be stored in memory 114. For example, the context types 140₁, 140₇, and 140₈ can be placed in a class 180₁ for having similar process data tags 130 in the respective rankings 160₁, 160₇ (not shown), and 160₈ (not shown). On the other hand, the context type 140₂ can be placed in a class 180₂ by itself because the process data tags 130 included in its ranking 160₂ were not similar enough to the rankings 160 for the other selected context types 140. The operations of context type classifying code 150 for classifying the context types 140 can be executed in different modes, where the different modes include conditions for classifying two or more selected context types 140 into the same class 180. The different modes and respective conditions are discussed below in reference to FIGS. 2A-2E.

If operations of the context type classifying code 150 place two or more context types 140 into the same class 180ₙ, an additional adjustment operation may be used to account for variations between the similar process data tags 130 of the context types 140 in the same class 180ₙ before a fault 170ₙ associated with the context types 140 can be modeled with the same multivariate model. For example, the context types 140₁ and 140₇ can each have a process data tag 130₈, a tag related to the mean of an amperage, as the top contributor in the respective rankings 160₁, 160₇. The context type 140₁ can be a Recipe 1, where the mean of the amperage related to process data tag 130₈ is controlled around 1 amp while the context type 140₇ can be a Recipe 7, where the mean of the amperage related to process data tag 130₈ is controlled around 1.2 amps. To model the related fault 170ₙ, a means test can be used to account for the differences of the means across the context types 140₁, 140₇. Similarly, a variance test can be used to account for differences in the variances of corresponding process data tags 130ₙ of the context types 140 placed in the same class 180ₙ.

FIGS. 2A-2E are block diagrams illustrating exemplary modes of classifying context types, according to one embodiment. FIG. 2A illustrates an example of classifying the context types 140 in a first mode 191. Referring to FIGS. 1A, 1B, and 2A, the first mode 191 is explained. FIG. 2A displays a ranking 160₁ for the context type 140₁ with a top-ranked process data tag 130₈ having a relative contribution 160_{1.1} of 0.60. FIG. 2A also displays a ranking 160₇ for the context type 140₇ with a top-ranked process data tag 130₃ having a relative contribution 160_{7.1} of 0.61. The context type classifying code 150 can be executed by processor 112 in the first mode 191. In the first mode 191, upon determining two or more selected context types 140₁, 140₇ are similar for having rankings 160₁, 160₇ with a same top-ranked process data tag 130₈, the processor 112 can create a class 180_{1.1} (also referred to as a first class) identifying the similar context types 140₁, 140₇. In investigating which context types 140 have a similar fault that can be successfully modeled with the same multivariate model, the investigation can begin by determining, which context types 140 share the same top process data tag 130 in their respective rankings 160.

FIG. 2B illustrates an example of classifying context types in a second mode 192. Referring to FIGS. 1A, 1B, and 2B, the second mode 192 is explained. FIG. 2B displays a ranking 160₁ for context type 140₁ with a top three process data tags 130₈, 130₁, 130₇ having respective relative contributions 160_{1.1}, 160_{1.2}, and 160_{1.3}. FIG. 2B also displays a ranking 160₇ for context type 140₇ with a top three process data tags 130₈, 130₇, 130₁ having respective relative contributions 160_{7.1}, 160_{7.2}, and 160_{7.3}. The context type classifying code 150 can be executed by the processor 112 in the second mode 192. In the second mode 192, upon determining two or more selected context types 140₁, 140₇ are similar for having rankings 160₁, 160₇ with a same top “N” process data tags 130₈, 130₁, and 130₇, the processor 112 can create a class 180_{1.2} (also referred to as a first class) identifying the similar context types 140₁, 140₇. In some embodiments “N” can be an integer between two and twenty, but in other embodiments N could be significantly higher. In the example in FIG. 2B, “N” is three to keep the example simple, but in some embodiments, “N” could be as high as fifty or one hundred. Higher values of “N” may generally cause narrower classifications as there is more process data tags considered in the classification. As FIG. 2B illustrates the context types 140₁, 140₇ are placed in the same class e.g., 180_{1.2} even when the process data tags 130₈, 130₁, and 130₇ are ranked in different orders (i.e., process data tag 130₇ is ranked third in ranking 160₁ and second in ranking 160₇).

FIG. 2C illustrates an example of classifying context types in a third mode 193. Referring to FIGS. 1A, 1B, and 2C, the third mode 193 is explained. FIG. 2C displays a ranking 160₁ for context type 140₁ with a top three process data tags 130₈, 130₁, 130₇ having respective relative contributions 160_{1.1}, 160_{1.2}, and 160_{1.3}. FIG. 2C also displays a ranking 160₈ for context type 140₈ with a top three process data tags 130₈, 130₁, 130₇ having respective relative contributions 160_{8.1}, 160_{8.2}, and 160_{8.3}. The context type classifying code 150 can be executed by the processor 112 in the third mode 193. In third mode 193, upon determining two or more selected context types 140₁, 140₈ are similar for having rankings 160₁, 160₈ with a same top “N” process data tags 130₈, 130₁, and 130₇ ranked in a same order (i.e., rankings 160₁, 160₈ both have the first three process data tags ranked as 130₈, 130₁, 130₇), the processor 112 can create a class 180_{1.3} (also referred to as a first class) identifying the similar context types 140₁, 140₈, wherein “N” is an integer between two and twenty. In the example in FIG. 2C, “N” is three to keep the example simple, but could be higher as described above.

FIG. 2D illustrates an example of classifying context types in a fourth mode 194. Referring to FIGS. 1A, 1B, and 2D, the fourth mode 194 is explained. FIG. 2D displays a ranking 160₁ for context type 140 with a top four process data tags 130₈, 130₁, 130₇, 130₃ having respective relative contributions 160_{1.1}, 160_{1.2}, 160_{1.3} and 160_{1.4}. FIG. 2D also displays a ranking 160₇ for context type 140₇ with a top four process data tags 130₈, 130₁, 130₇, 130₄ having respective relative contributions 160_{7.1}, 160_{7.2}, 160_{7.3}, and 160_{7.4}. The context type classifying code 150 can be executed by the processor 112 in the fourth mode 194. In fourth mode 194, upon determining two or more selected context types 140₁, 140₇ are similar for having rankings 160₁, 160₇ with at least a same “M” process data tags out of a top “N” process data tags, the processor 112 can create a class 180_{1.4} (also referred to as a first class) identifying the similar context types 140₁, 140₇, wherein “N” is an integer between two and twenty and “M” is an integer less than “N”. In the example in FIG. 2D, “M” can be two or three and “N” is four to keep the example simple, but both can be higher similar to what has been described above.

FIG. 2E illustrates an example of classifying context types in a fifth mode 195. Referring to FIGS. 1A, 1B, and 2E, the fifth mode 195 is explained. FIG. 2E displays a ranking 160₁ for context type 140₁ with a top three process data tags 130₈, 130₁, 130₇ having respective relative contributions 160_{1.1}, 160_{1.2}, and 160_{1.3}. FIG. 2E also displays a ranking 160₈ for context type 140₈ with a top three process data tags 130₈, 130₁, 130₇ having respective relative contributions 160_{8.1}, 160_{8.2}, and 160_{8.3}. The context type classifying code 150 can be executed by the processor 112 in the fifth mode 195. In fifth mode 195, upon determining two or more selected context types 140₁, 140₈ are similar for having rankings 160₁, 160₈ with a same top “N” process data tags 130₈, 130₁, and 130₇ and upon determining that the relative contribution of each process data tag 130ₙ within each ranking 160₁, 160₈ of the similar context types 140₁, 140₈ is within a margin of error 115 (e.g., 0.02 here) from the relative contribution of the corresponding process data tag 130ₙ in the one or more other rankings 160₈, 160₁ of the similar context types, the processor 112 can create a class 180_{1.5} (also referred to as a first class) identifying the similar context types 140₁, 140₈, wherein “N” is an integer between two and twenty. In the example in FIG. 2E, “N” is three to keep the example simple, but can be higher as described above.

The margin of error 115 can also be stored in memory 114 and in some embodiments, the margin of error 115 can be adjustable by a user. The margin of error 115 can be an absolute value of the difference between the relative contributions of corresponding process data tags 130ₙ. In FIG. 2E, the margin of error 115 is set to 0.02. Because all of the process data tags 130₈, 130₁, 130₇ in the ranking 160₁ are within the margin of error 115 from the corresponding process data tag 130₈, 130₁, 130₇ in the ranking 160₈, the rankings 160₁, 160₈ can be placed in the same class 180_{1.5} under the fifth mode 195. The margin of error 115 can also be a percentage difference between the relative contributions of corresponding process data tags 130ₙ or any other metric commonly used to determine if two values are similar.

The modes 191-195 described in reference to FIGS. 2A-2E are some of the ways that similar context types associated with similar faults can be identified. The more similar that context types are in regard to the process data tags included in the rankings generated by execution of the context type classifying code 150, the more likely the similar fault for the context types can be successfully modeled using the same multivariate model. The similarity between context types placed in the same class can be increased in a number of ways. First, the value of “N” can be increased in the second mode 192 through the fifth mode 195. Second, the value of “M” can be increased for the fourth mode 194. Third, the margin of error in the fifth mode 195 can be decreased. Also, features of the different modes can be combined to increase the similarity between the context types placed in the same class. For example, another mode can combine the modes 193 and 195, so that the top “N” process data tags need to be ranked in the same order for the third mode 193 and meet the margin of error specified for the fifth mode 195.

After the context types 140 are placed into different classes using the context type classifying code 150, a multivariate model may be developed for one or more of the classes. For example, if a first class includes 15 context types and a second class includes 4 context types, then one multivariate model can be developed for the first class and a different multivariate model may be developed for the second class. The multivariate model(s) may be added to the fault code 190 or each instance of the fault code 190 that may be distributed across multiple devices as described above. The fault code 190 can also include the fault routine discussed above. The fault routine can include conditions for determining when a process associated with the context types of the first class is in a fault condition with respect to a multivariate model developed for the selected fault (i.e., the fault 170ₙ selected when the context classifying code 150 was executed). The fault code 190 can be executed by the processor 112 to perform operations for determining when the selected fault has occurred on one of the context types of the first class. For example, the fault code 190 can include operations for updating the values of the process data tags 130 associated with the context type 140 that is being monitored by execution of the fault code for the selected fault. In some embodiments, the values may be updated multiple times per second, such as every 50 ms.

Taking the arcing electrode example discussed above, the fault code 190 can be used to monitor the values, such as a temperature, a voltage, and a current from sensors associated with the electrode to detect the arcing electrode fault. These values may then be applied to an algorithm that is designed to fit the multivariate model when the process associated with the context type (e.g., the process that uses the electrode in this example) is operating in a normal or alarm-free condition with respect to the arcing electrode fault. The output of the algorithm may then be compared to the multivariate model to determine how much the output of the algorithm deviates from the normal or non-alarm value predicted by the multivariate model. The fault, such as an occurrence of the arcing electrode, may then be detected when the output of the algorithm deviates from the multivariate model in a specific way (a fault signature). For example, the rankings 160ₙ discussed above (see FIGS. 2B-2E), showed how the different process data tags 130 included in a ranking 160, have different relative contributions to a fault. Referring to FIG. 2C, the particular fault may be detected when the process data tags 130₈, 130₁, 130₇ all deviate from normal values, the process data tag 130₈ deviates more than the process data tag 130₁, and the process data tag 130₁ deviates more than the process data tag 130₇. Depending on the type of fault, the process associated with the context type may be stopped when the fault is detected. For example, if an arcing electrode is likely to damage product being produced by the process, then the fault code 190 can include instructions to stop the process being executed. Other multivariate faults may not be as important to the current process being executed and may only indicate that maintenance should be performed during the next downtime of the machine or tool.

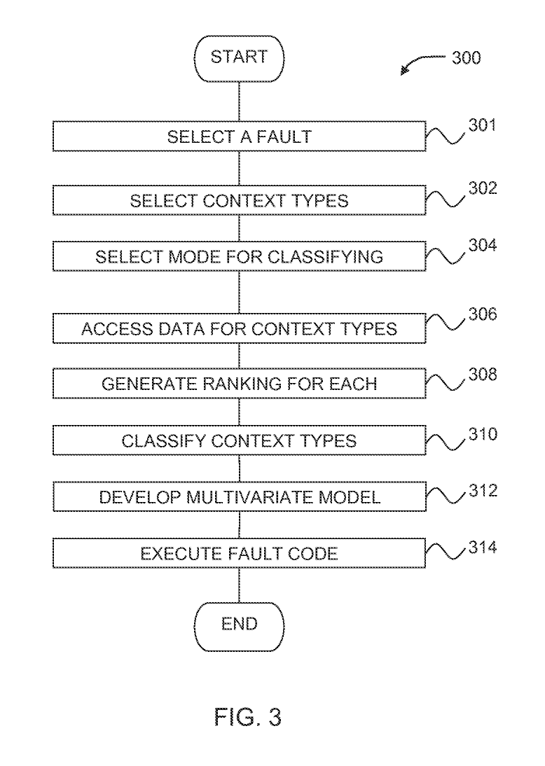

Referring to FIGS. 1A, 1B and 3 a method 300 is described for determining two or more context types having an associated fault to be modeled by the same multivariate model. Although the method is described in conjunction with reference to the systems of FIGS. 1A, and 1B, persons skilled in the art would understand that any system configured to perform the method operations, in any order, is within the scope of the embodiments disclosed. The method 300 can be executed on a computing system, such as the context type classifying system 100.

At block 301, a fault 170ₙ is selected. For example, a user could select the arcing electrode fault discussed above. At block 302, two or more context types 140 are selected. The selection can be made by a user on the user interface 20. In some embodiments, a user can select individual context types 140ₙ, such as selecting a context type of Recipe 1 on Tool 1. In other embodiments, a user may be able to select multiple context types 140 with one selection, such as selecting a fault 170ₙ and then the context type classifying code 150 can be executed to select all context types associated with the fault 170ₙ. A user can also select a machine to select all context types, such as recipes, associated with that machine.

At block 304, a mode, such as the modes 191-195, for classifying the two or more context types 140 can be selected. The mode selected controls what context types can be classified together. For example, first mode 191 can be used to create one or more classes 180 for context types 140 having rankings 160 sharing a top-ranked process data tag. The operations of the different modes are described in detail in reference to FIGS. 2A-2E and are not repeated here. In some embodiments, a user can select the mode. In other embodiments, block 304 can be optional as the mode could be hard-coded. In other embodiments, the mode can be determined by the code 150 based on the type of context types 140 selected.

At block 306, historical values stored in the memory 114 for process data tags 130 related to the selected context types 140 are accessed, for example, by the processor 112 executing the context type classifying code 150.

At block 308, the processor 112 can generate rankings 160 of the process data tags 130 for each selected context type 140ₙ. Each ranking 160ₙ can include the process data tags 130 ranked according to relative contributions of each process data tag 130ₙ in the ranking 160ₙ to a fault 170ₙ associated with the context type 140. The context type classifying code 150 can be executed to generate the rankings 160 by using multivariate analysis techniques, such as Partial Least Squares, AdaBoost, and RankBoost as discussed above.

At block 310, the processor 112 can classify the context types 140 into one or more classes 180 based on the process data tags 130 included in each ranking 160ₙ. The classes 180 can also be stored in the memory 114. The one or more classes include a first class that includes two or more of the selected context types 140. The operations of the context type classifying code 150 for classifying the context types 140 can be executed in the different modes 191-195, the different modes including conditions for classifying two or more selected context types 140 into the same class 180ₙ. The different modes 191-195 and respective conditions were discussed in detail in reference to FIGS. 2A-2E and are not repeated here.

At block 312, a multivariate model is developed for the selected fault for the first class that includes two or more of the selected context types 140. The multivariate model is used in the fault code 190 along with the fault routine to detect when a particular multivariate fault, such as the selected fault, occurs as described above. At block 314, the fault code 190 is executed to determine when the selected fault has occurred on one of the context types 140 of the first class. The fault code 190 includes conditions for determining when the process associated with the context types of the first class is in a fault condition with respect to the multivariate model for the selected fault. For example, the fault code 190 for the arcing electrode example discussed above may be executed when the electrode is energized during the process that uses that electrode. Furthermore, as discussed above the fault code 190 can be used to stop the process associated with the context type when the selected fault is detected.

Referring to FIGS. 1A, 1B, 2A-2E, and 3 the method and system described provides numerous advantages. As mentioned above, developing multivariate models is time consuming and thus quite expensive. Developing separate multivariate models to detect a similar multivariate fault for each machine, recipe, or event or attempting to leverage multivariate models for detecting similar faults on similar machines, recipes, or events with a trial and error approach can be costs that outweigh the potential benefits gained from using the multivariate models. In such situations, the models simply will not be developed.

By using the method 300 described above, the costs of developing the models to detect a fault for each context type (e.g., equipment, recipe, event) can be greatly reduced because the method 300 can identify context types that can use the same model. Some groups of context types may need higher degrees of similarity before a fault associated with the context types can be successfully modeled by the same multivariate model. A user can adjust the degree of similarity for context types to be placed in the same class to increase the likelihood that the fault associated with the context types placed in the same class can be successfully modeled by the same multivariate model. As mentioned above, a user can adjust this degree of similarity by increasing the value of integer “N” in the second mode 192 through the fifth mode 195 or the value of “M” for the fourth mode 194, or by decreasing the margin of error in the fifth mode 195.

The knowledge that a single model can be leveraged on multiple context types creates more situations where the benefits of the multivariate model begin to outweigh the costs of model development. This cost reduction allows for more opportunities for equipment owners to capture all of the benefits that using multivariate models can create. As mentioned above, such benefits can include improved product quality as well as reduced downtime and reduced maintenance costs. Furthermore, using the method 300 on multiple groups of context types can provide the opportunity for an equipment owner to determine which group(s) should be modeled first. For example, the method 300 can be applied to a fault occurring in two groups of recipes. The method 300 can show that 27 recipes from the first group can use the same model while only 3 recipes from the second group can use the same model. Based on this result, the owner can determine that developing the multivariate model for the first group as opposed to the second group is more financially beneficial.

While the foregoing is directed to typical embodiments, other and further embodiments may be devised without departing from the basic scope thereof, and the scope thereof is determined by the claims that follow.

What is claimed is:

1. In a computing system having a memory storing data associated with two or more context types, a method for determining two or more context types having an associated fault to be modeled by a same multivariate model, the method comprising:
selecting a fault;
selecting two or more context types associated with the fault;
accessing historical values stored in the memory for process data tags related to the selected context types;
generating rankings of process data tags for each selected context type, each ranking comprising process data tags ranked according to relative contributions of each process data tag in the ranking to the fault;
classifying the context types into one or more classes based on the process data tags included in each ranking, the one or more classes including a first class that includes two or more of the selected context types; and
deploying a multivariate model operable to monitor processing equipment for the selected fault for the first class of context types.

2. The method of claim 1, wherein two or more selected context types are placed in the first class for having rankings with a same top-ranked process data tag.

3. The method of claim 1, wherein two or more selected context types are placed in the first class for having rankings with a same top “N” process data tags, creating a class identifying the similar context types, wherein “N” is an integer between two and twenty.

4. The method of claim 1, wherein two or more selected context types are placed in the first class for having rankings with a same top “N” process data tags ranked in a same order, creating a class identifying similar context types, wherein “N” is an integer between two and twenty.

5. The method of claim 1, wherein two or more selected context types are placed in the first class for having rankings with at least a same “M” process data tags out of a top “N” process tags, creating a class identifying the similar context types, wherein “N” is an integer between two and twenty and “M” is an integer less than “N”.

6. The method of claim 1, further comprising executing a fault routine to determine when the selected fault has occurred on one of the context types of the first class, the fault routine including conditions for determining when a process associated with the context types of the first class is in a fault condition with respect to the multivariate model for the selected fault.

7. The method of claim 6, wherein the two or more context types of the first class are machines and the method further comprises stopping a process being executed on one of the machines when execution of the fault routine indicates that the fault condition for the multivariate model has occurred for the selected fault.

8. A system for classifying context types for multivariate modeling of faults associated with the context types, the system comprising:
a processor;
a memory for storing data associated with two or more context types, a first code, and a second code, wherein the first code when executed by the processor, performs operations comprising:
accepting a selection of a fault;
accepting a selection of two or more context types associated with the fault
accessing historical values stored in the memory for process data tags related to the selected context types;
generating rankings of process data tags for each selected context type, each ranking comprising process data tags ranked according to relative contributions of each process data tag in the ranking to the fault;
classifying the context types into one or more classes based on the process data tags included in each ranking, the one or more classes including a first class that includes two or more of the selected context types; and
the second code when executed by the processor, performs operations comprising:
using a multivariate model to monitor processing equipment for the selected fault for the first class of context types.

9. The system of claim 8, wherein two or more selected context types are placed in the first class for having rankings with a same top-ranked process data tag, creating a class identifying the similar context types.

10. The system of claim 8, wherein two or more selected context types are placed in the first class for having rankings with a same top “N” process data tags, creating a class identifying the similar context types, wherein “N” is an integer between two and twenty.

11. The system of claim 8, wherein two or more selected context types are placed in the first class for having rankings with a same top “N” process data tags ranked in a same order, creating a class identifying similar context types, wherein “N” is an integer between two and twenty.

12. The system of claim 8, wherein two or more selected context types are placed in the first class for having rankings with at least a same “M” process data tags out of a top “N” process tags, creating a class identifying the similar context types, wherein “N” is an integer between two and twenty and “M” is an integer less than “N.”

13. The system of claim 8, wherein the second code when executed by the processor, performs operations further comprising:
executing a fault routine to determine when the selected fault has occurred on a context type of the first class, the fault routine including conditions for determining when a process associated with the context types of the first class is in a fault condition with respect to a multivariate model developed for the selected fault.

14. The system of claim 13, wherein the two or more context types of the first class are machines and the execution of the second code further comprises stopping a process being executed on one of the machines when execution of the fault routine indicates that the fault condition for the multivariate model has occurred for the selected fault.

15. A non-transitory computer-readable storage medium storing a first code and a second code for execution by a processor, wherein the first code, when executed by the processor, performs operations for determining two or more context types associated with a fault to be modeled by a same multivariate model, the operations comprising:
accepting a selection of a fault;
accepting a selection of two or more context types associated with the fault;
accessing data stored for the selected context types;
generating rankings of process data tags for each selected context type, each ranking comprising process data tags ranked according to relative contributions of each process data tag in the ranking to the fault;
classifying the context types into one or more classes based on the process data tags included in each ranking, the one or more classes including a first class that includes two or more of the selected context types; and
the second code when executed by the processor, performs operations comprising:
using a multivariate model to monitor processing equipment for the selected fault for the first class of context types.

16. The computer-readable storage medium of claim 15, wherein two or more selected context types are placed in the first class for having rankings with a same top-ranked process data tag, creating a class identifying the similar context types.

17. The computer-readable storage medium of claim 15, wherein two or more selected context types are placed in the first class for having rankings with a same top “N” process data tags, creating a class identifying the similar context types, wherein “N” is an integer between two and twenty.

18. The computer-readable storage medium of claim 15, wherein two or more selected context types are placed in the first class for having rankings with a same top “N” process data tags ranked in a same order, creating a class identifying similar context types, wherein “N” is an integer between two and twenty.

19. The computer-readable storage medium of claim 15, wherein two or more selected context types are placed in the first class for having rankings with at least a same “M” process data tags out of a top “N” process tags, creating a class identifying the similar context types, wherein “N” is an integer between two and twenty and “M” is an integer less than “N.

20. The computer-readable storage medium of claim 15, wherein two or more selected context types are placed in the first class for having rankings with a same top “N” process data tags and upon determining that the relative contribution of each process data tag within each ranking of the similar context types is within a margin of error from the relative contribution of a corresponding process data tag in the one or more other rankings of the similar context types, creating a class identifying the similar context types, wherein “N” is an integer between two and twenty.
